(19) United States
(12) Patent Application Publication
(10) Pub. No.: US 2025/0065602 A1
(43) Pub. Date: Feb. 27, 2025

(54) COMPOUND MATERIAL, PARTICULARLY COMPOSITE MATERIAL

(71) Applicant: METRON EGING GMBH, Eging am See (DE)

(72) Inventor: Josef Andreas HROVATH, Riegersdorf (AT)

(21) Appl. No.: 18/723,451

(22) PCT Filed: Dec. 23, 2021
(86) PCT No.: PCT/EP2021/087546

§ 371 Date: Jun. 23, 2024

(51) Int. Cl. B32B 7/12; B32B 7/06; B32B 9/00; B32B 15/20; B32B 17/00; B32B 21/00; B32B 27/02; B32B 27/28

(52) U.S. Cl. CPC B32B 7/12; B32B 7/06; B32B 9/002; B32B 9/005; B32B 15/20; B32B 17/00; B32B 21/00; B32B 27/02; B32B 27/28; B32B 2307/30; B32B 2307/716

(57) ABSTRACT

A compound material, especially a recyclable composite material which consists of at least two material layers bonded by a layer of adhesive. For easy and clean separation of the two material layers, the adhesive consists of a material that gives off and/or generates water vapor when heated to more than 100° C., thereby separating the composite into its constituents.

### TECHNICAL FIELD

The present disclosure relates to compound materials. More particularly, the present disclosure relates to a composite material, especially a sandwich composite material, and a method for producing it and for separating the composite into its constituents.

### BACKGROUND

In sandwich constructions, materials with different properties are assembled in layers to form a component or semi-finished product. The sequence of cover layer-core-cover layer is typical, but not mandatory. The core and the cover layer are usually permanently connected to one another, especially if the core consists of thermoset polymers and foams that are only crosslinked or foamed during the manufacturing process, such as rigid polyurethane (PU) foam, rigid polystyrene (PS) foam, expanded polystyrene (EPS) rigid foam, or particle foams made from EPS, expanded polyethylene (EPE) and expanded polypropylene (EPP). Particularly when producing sandwich structures based on thermoset polymers (resins) and/or foams, it is not possible to separate the materials from each other after use or failure of the component/semi-finished product without high heat input or use of aggressive chemicals (e.g. strong acids and alkalis). There are already special dissolvable (recyclable) epoxy resin systems for sandwich composite materials, especially fiber-reinforced composites made of glass fibers, carbon fibers, natural fibers, etc., which allow the components of the sandwich composite to be separated under relatively mild conditions (slightly acidic environment) by dissolving the resin system (EP2646410B1, DE19733643A1), but this process takes at least 60 minutes and only works if the separable material layers (in this case the recyclable epoxy resin) are easily accessible to the solvent.

If the compression between the core and the cover layer is too strong (e.g. with expanding reactive foam), the solvent cannot penetrate deeply enough into the adhesive layer, which means that this layer cannot be dissolved and no separation can take place. A possible solution is the use of adhesives mixed with thermally decomposable substances, such as hollow microspheres (EP 1 111 020 A2, DE102009019484A1). The problem here is that, depending on the substance and carrier matrix used (such as a reactive 2-component resin system), cleaning the surface of the cover layer and/or core layer is not possible without harmful solvents or a strongly acidic/basic environment. Contamination of the components of the sandwich composite, on the other hand, either severely limits the recyclability of the components or prevents it entirely. For most materials, but especially for PU-based materials, recycling is only possible if the PU residues are free of any adhesion and contamination (www.linzmeier.de/downloads/recycling). In addition, the examples set out in the relevant disclosures only contain adhesion promoter variants based on fossil and non-renewable raw materials, which significantly limits the environmental friendliness of the material combinations. With the variants set out in EP 1 111 020 A2, which refer to one-or two-component polyepoxides with water vapor-generating, thermally activated substances which are dispersed in the binder in amounts between 1 and 20% by weight, in some cases not enough water vapor can be produced to separate layers that have been joined under high pressure.

Given this state of the art, it is currently not possible to form connections of two materials, in particular sandwich composite components, such as panels made of a pressure-resistant thermoset fiber-reinforced cover layer and a thermoset or thermoplastic foam core and/or another core construction (honeycomb, lattice or foam structure) made of natural materials such as wood, bamboo, flax, etc. or from synthetic and/or bio-based polymers such as EPS, PLA, PP, PHBS, which are connected to a cover layer by thermoset polymers, which can be separated into their components with little energy expenditure, without aggressive chemicals, in a timely and efficient manner and in an unmixed state (GB2513834A, U.S. Pat. No. 8,776,698B2, U.S. Pat. No. 8,808,833B2). This includes not only two-dimensional panels, but also three-dimensional component structures created using shaping processes such as by using pressing tools. The lack of or disadvantageous options for separating the parts into their components impair or completely prevent the recycling of such material connections and of the corresponding composite material components, which has a negative impact on their environmental balance.

The following facts are known in the prior art:
Dissolvable adhesives based on epoxy with thermally decomposable substances in proportions of 1-20% by weight, which release water vapor when heated or hollow microspheres (EP 1 111 020 A2, DE102009019484A1)
Separation methods for sandwich composite materials with recyclable epoxy under mild conditions or re-dissolvable adhesion promoters of other types (EP2646410B1, DE19733643A1)
Methods for producing sandwich composite panels with a foam core or honeycomb core and various cover layers (GB2513834A, U.S. Pat. No. 8,776,698B2, U.S. Pat. No. 8,808,833B2)
Components and semi-finished products made of composite materials in sandwich construction (wall/floor elements, board sports articles, insulating elements, floor coverings, reinforcing elements) that cannot currently be recycled because the materials used cannot be separated cleanly from one another-especially in the combination of a core made of PU rigid foam

The object of the present disclosure is to avoid the disadvantages mentioned above and to achieve the indicated advantages.

### SUMMARY

The present disclosure is directed to compound materials, especially recyclable composite materials that consist of at least two material layers bonded by a layer of adhesive. For easy and clean separation of the two material layers, the adhesive consists of a material that gives off and/or generates water vapor when heated to more than 100° C., thereby separating the composite into its constituents.

In some examples, the disclosure includes compound material having at least two material layers bonded by a layer of an adhesive, where the adhesive includes a material that produces water vapor when heated to more than 100° C.

In some examples, the disclosure includes methods for releasing a bond of a compound material, the compound material having at least two material layers bonded to one another by a layer of an adhesive that includes a material that produces water vapor when heated to more than 100° C., where the method includes heating the compound material to over 80° C.

### BRIEF DESCRIPTION OF THE DRAWINGS

FIG. 1 schematically depicts an exemplary compound material having a sandwich structure according the present disclosure.

FIG. 2 schematically depicts an exemplary compound material having a combination of two different materials according to the present disclosure.

FIG. 3 schematically depicts an exemplary compound material having a combination of two identical materials according to the present disclosure.

FIG. 4 schematically depicts an exemplary compound material that is a 3-dimensionally curved sandwich variant, according to the present disclosure.

### DETAILED DESCRIPTION

The present disclosure provides compound materials that avoid the disadvantages mentioned above, and achieve the desired advantages. The disclosed compound materials include the use of an adhesive layer or intermediate layer (adhesive layer with a separating effect) between the connection of two materials, such as a cover layer and a core (or a second cover layer, generally a layer one and a layer two), the adhesive strength of which is eliminated or at least largely reduced by heating to over 100° C. and by subsequent giving off/generating of water vapor. It is then possible to completely separate this adhesive or intermediate layer from the component or materials within less than 24 hours without the use of dangerous and aggressive chemicals or heat and without affecting its physical properties by storing it for a maximum of 24 hours in a mildly acidic aqueous solution (such as a 5-25% aqueous ethyl acetate solution) so that all components except for the adhesive layer can be recycled or reused. This is made possible by using special hardener components to crosslink the (poly) epoxides of the adhesive layer, which are based on diamine-acetal and diamine-ketal derivatives and can be dissolved in a mildly acidic aqueous solution at room temperature.

In a further embodiment, hardener components based on thermolabile polyimine compositions can be used to crosslink the (poly) epoxides of the adhesive layer, which compositions can be redissolved in the aqueous ethyl acetate solution or in ethanol with the addition of 30-50% by volume of triethylenetetramine. Adhesive layers produced in this way lose their adhesive properties even without the addition of water vapor-generating, thermally activated substances simply by heating to over 80° C. The special properties are based on rearrangements of the chemical bonds in the polymer network using catalyzed transesterification, which thereby cause a change in the number of bonds within the network.

Finally, in a further embodiment, the proportion of regenerative (bio-based) raw materials in the adhesive layer according to the present disclosure is at least 24% by weight. For this purpose, BPA or glycerol-based (poly) epoxides are used, which contain a proportion of carbon from renewable sources in the molecular structure that can be determined according to ASTM D6866. The proportions of carbon from renewable sources can be:
epoxidized vegetable oils, such as soybean oil, castor oil, linseed oil, cashew nut shell oil
epoxidized sorbitol and glycerol derivatives
lignin, tannin or cellulose derivatives

The materials used, the various heating options and the details of the separation method are described in detail below.

The present disclosure thus provides a method for producing, in particular, environmentally friendly composites that can be recycled in a sorted manner, of several, but at least two materials, in particular sandwich composite materials made of at least one cover layer and one core material. The disclosure also includes the associated separation method for the components of the sandwich composite materials produced in this way. After their life cycle, these can be separated without aggressive chemicals without the use of high temperatures so that the materials used can be reused or recycled after less than 24 hours. Particularly for components that consist of a cover layer and a

PU core material, the recyclability of which is now severely limited, the disclosure provides the production of more environmentally friendly variants, which, for example in the construction industry, can make a significant contribution to improving the sustainability of the entire construction sector. One of the variants listed allows the production of fully recyclable sandwich components/semi-finished products made of rigid PU foam and a natural fiber cover layer with a proportion of renewable (bio-based) resources of up to 70%.

The present disclosure also includes the sandwich components produced from a core made from PU rigid foam (partly based on regenerative raw materials), from a polymeric lattice structure (in particular additively manufactured from ABS, PLA, PP, PET and their composites) or from wood-based materials and at least one cover layer made of ceramic materials, natural stone-based materials, wood and wood veneer, or (natural) fiber-reinforced thermoset composites.

### Summary of Advantages:

Environmental friendliness by increasing the proportion of renewable resources and improving recyclability through improved cleaning of the components
Creating opportunities for circular product design
Production of recyclable sandwich components from and with various rigid foam or particle foam core variants made from PU, EPS, PP, EPE, PS, EPP, PLA, EPLA
Economic efficiency (faster process of separating materials from each other)
Ecological efficiency (less material and lower toxicity of the components as well as the materials required for separation)

### Application Areas:

Construction industry: insulating elements, floor coverings, wherever polyurethane rigid foam and the other rigid foam and particle foam core variants mentioned in the text are used, which are stiffened/protected by a cover layer.
Sandwich panels for floor and wall elements
Board sports items: skis, snowboards, surfboards, skateboards, kiteboards, SUPs, etc.
Reinforcing elements for surfaces and covering layers made of natural stone, ceramics, veneer, etc.

### Material Examples for the Composite Materials and Structures Thereof:

The composite materials mentioned either have a classic sandwich structure consisting of a core and at least one cover layer, but can also represent a combination of two different materials with different properties, such as a brittle surface (ceramic, natural stone, concrete, etc.) and a ductile material (e.g. fiber fabric and fabric). A structure is also possible that connects two identical materials together via a re-dissolvable adhesive layer and these can then be separated.

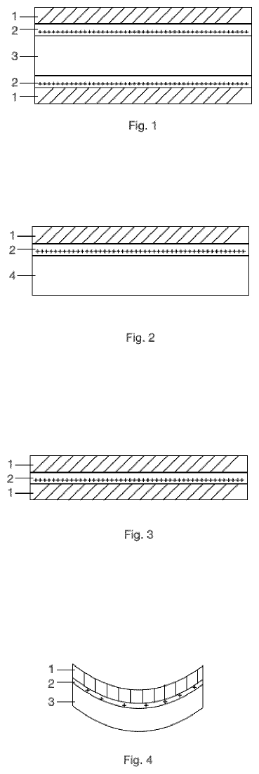

The compound materials of the present disclosure are depicted schematically in FIGS. 1-4, where the reference numerals stand for:
1 body made of a first material
2 adhesive layer
3 core
4 body made of a second material

The dots and lines shown in the adhesive layer indicate that reinforcement in the form of fibers, a fleece and the like and/or an additive in the form of a conductive substance can optionally be provided.

It should also be noted that in the description and the claims the adhesive layer is also referred to synonymously as a separating layer, separating plane (because it not only connects the other two layers, but also separates them).

The composite materials can either be produced in two-dimensional plate, beam or cuboid form or can result in any three-dimensional structures using forming methods (pressing technology) (FIG. 4).

The cover layers and materials to be connected can have any thickness, preferably in the range from 0.1 mm to 100 mm, and can consist of the following materials or material classes:
Wood: wood panels, wood plates, wood veneer, wood fabric, wood scrim, wood composites
Glass: glass pane, glass composites, glass plates
Ceramics: ceramic tiles, ceramic plates, ceramic composites
Natural stone: natural stone slabs, natural stone composites, natural stone tiles
Polymers (thermoplastic/thermosetting): PP, PET, PLA, PA, PU, ABS, polyester, epoxy, etc., fiber-filled polymers, polymer sheets, polymer films, polymer layers, roll goods
Fiber fabrics/wovens and composites made from them: carbon fibers, natural fibers (flax, hemp, bamboo, kenaf, etc.), glass fibers, aramid fibers, basalt fibers
Metals: Aluminum

The cores and core components contain at least one material, but can also consist of different material classes. They can also come in any thickness, preferably in the range from 1 mm to 300 mm. The cores can be foamed (open cell, closed cell, particle foam), 3D printed (lattice or closed structure), or extruded (plate shape, honeycomb structure, etc.) and consist of the following materials:
Polymers of any kind, especially Rigid foams made from thermoset reactive resin systems such as PU or epoxies and from thermoplastic polymers such as EPS, EPE, EPP, PLA and others
Fiber-filled composites made from the above-mentioned polymers
Wood and wood-based materials, such as WPC (wood plastic composites)
Metal and metal-based materials, such as aluminum foams or mesh structures.
Recycling materials, especially made of plastic, such as rPET foams or rPET honeycomb cores

More detailed description of the invention (production and separation of recyclable sandwich composite materials)

The present disclosure includes a method for producing recyclable sandwich composite structures, as well as for separating them into individual components that can either be reused or completely recycled. The disclosure also includes the components resulting from the manufacturing process. The disclosure refers specifically to sandwich structures made of a PU foam core and a ceramic cover layer, but can be transferred to any combination of materials mentioned under “material examples”.

### Novelty:

Manufacture of components/semi-finished products made from composite materials in sandwich construction, which can be separated from each other more efficiently (non-toxic, less energy required, shorter time) and cleaner due to the presented method. This creates more environmentally friendly versions of the products mentioned above, which also allow circular economy applications and business models (wall/floor elements, board sports items, insulating elements, floor coverings, reinforcing elements, surfaces)
In relation to the above-mentioned facts, the following improvements result compared to: EP 1 111 020 A2 and DE102009019484A1: More environmentally friendly, due to the use of renewable raw materials and simplified cleaning of the components; thermally activated substances can be added in a higher percentage by weight of up to 35% in order to achieve a stronger separating effect. Compared to: EP2646410B1 and DE19733643A1: faster method, compared to: GB2513834A, U.S. Pat. No. 8,776,698B2, U.S. Pat. No. 8,808,833B2: recyclability.

The content of the publications mentioned is made the content of this description for the jurisdictions in which this is possible.

This results in the following special features of the present disclosure and

its different forms and developments:
1. At product/component level: fully recyclable components made from a rigid foam based on PU, epoxy, EPS, EPE, EPP, PLA or particle foam based on EPS, EPE, EPP, PLA and cover layers made from various materials including environmentally friendly separation methods for the components for enabling sorted recycling. The component design can be transferred to applications and products in the areas of walls, floors, skis, snowboards, surfboards, etc., which leads to a measurable improvement in the CO2 balance through an increased recycling rate
2. At the technology level: new separation method for composite materials from core and cover layer, wherein core and cover layers can be specified in detail
3. At the material level (dissolvable adhesion promoters, adhesive layer): new special combination of bio-based epoxy resin systems with a new class of acid-labile hardener components based on diamine ketal and/or acetal and thermally labile hardener components based on polyimine derivatives. With additional thermally activated additives, separating layers can be produced for all possible composite systems that can be removed from the component in an environmentally friendly and easy way without leaving any residue.

Further details about the disclosed materials:

An adhesive layer creates a separating plane (separating layer) between the two different materials or the cover layer and the core, which can be dissolved in a targeted manner. This separation layer consists of a acid-soluble bio-based duroplastic matrix with a specific brittleness of 7H to 9H determined by measurement of the pencil hardness degree according to ASTM D 3363) or a conductive matrix (e.g. water-based polyacrylate system with carbon nanotubes-“heating colour”), which has a crystalline water-containing salt as an additive (e.g. Na₂CO₃·10H₂O—sodium carbonate decahydrate). For this purpose, a mixture of bio-based, acid-labile resin system with a proportion of 20-99% of regenerative (renewable) raw materials (=bio-resin) and with a variable proportion of 0.5-35% of an inorganic salt containing crystal water is applied as a thin layer. After the mixture has hardened, the cover layer can be used as usual in the respective manufacturing process (e.g. foaming in a pressing tool). The same applies to joining two identical or different material layers. The mixture of bio-resin and additive is also applied to the surface of one layer of material facing the adhesive surface and either hardened or still in the uncrosslinked state, it is joined to the second layer of material in order to form the adhesive effect via the bio-resin mixture.

The components of the composite component are separated by heating the component to 100-105° C., which releases the crystal water contained in the lattice structure and weakens the adhesive effect of the adhesive layer. The different layers of material can then be easily removed. The components of the part can then be freed and cleaned from the residues of the adhesion promoter by storing them for a maximum of 24hours in a mildly acidic aqueous solution (e.g. 5-25% aqueous ethyl acetate solution) or an acidic imine or triethylenetriamine solution without affecting their properties. Depending on the type of components, they can then either be reused, recycled or composted.

The present disclosure also relates to adhesion promoter compositions based on epoxy resins (acid-labile, from renewable resources and without BPA) and so-called diamine or polyimine hardeners or water-based polyacrylate resins, which can also be conductive or made conductive by adding conductive substances. Furthermore, the resin systems contain non-toxic additives containing crystal water (inorganic salts) in a proportion of 1 to a maximum of 35% by weight.

According to ASTM D6866, the proportion of renewable raw materials in the resin system is determined by the proportion of carbon from renewable sources in the molecular structure of the resin system and is at least 20%. A particularly environmentally friendly variant is based on formulations without the carcinogenic bisphenol A (BPA) and a proportion of renewable raw materials of over 70%. The systems are particularly characterized by the fact that, due to the selection of special diamine and polyimine hardeners, the resin can be dissolved under very mild conditions (acetic acid, addition of the imine monomer or tetraethylenetriamine). This means that the interconnected components of the components or products can be easily cleaned of resin residues and either reused or recycled according to type.

Another object of this disclosure is the use of a non-toxic, inorganic salt containing crystal water in the separating plane, especially in foamed sandwich composite structures, in which penetration of the acidic solution into the acid-labile separating plane is prevented due to the high density of the core. The salt serves to induce the separation of the components of the part by heating to 100° C., because this causes a layer of water to form between the adhesion promoter and the components to which it has been applied and the adhesion effect is thus eliminated. Salts with more than four molar equivalents of crystal water, such as the salt Na₂CO₃·10H₂O (sodium carbonate decahydrate), are particularly suitable because they contain a lot of water in the crystal structure.

In a slight modification, instead of an epoxy resin, a conductive water-based polyacrylate can be used as a carrier for the salt, which has been made conductive by adding at least 0.5% by weight of nanoscale carbon modifications (e.g. carbon nanotubes). In this configuration, the separation effect can be achieved at room temperature by connecting a power source to previously attached contact points on the polyacrylate. The current flow causes the polyacrylate to heat up to over 100° C. and also releases the crystal water in the salt, which in turn weakens the adhesive effect.

The composite components that were joined using this method and can be separated using the methods described are also part of the present disclosure. The composite components can be:
Floor panels, wall elements, roof elements, doors
Door and other panels in the automotive sector
Interior and exterior cladding elements for leisure, rail and transport vehicles
Board sports items such as skis, snowboards, surfboards, kiteboards, skateboards, etc.
Surfaces made of ceramic and natural stone that are reinforced with fiber fabrics and/or foams

### APPLICATION EXAMPLES

In the description, especially in the examples, the adhesive or the layer of adhesive is also called: “adhesive agent” or: “separation layer”, but always means the material that connects the two layers to each other (in a soluble way).

### Example 1: Production of a Recyclable Floor Element made of Partially Bio-Based PU Rigid Foam and a Cover Layer made of Ceramic, Glass, Natural Stone such as Granite or Basalt, or a Combination of These Cover Layers

Adhesive layer: BPA-free glycerol-based 2K bio-epoxy resin with an acid-labile recyclable hardener with the addition of Na₂CO₃·10H₂O

### Brief Description of the Disclosed Materials:

A surface made of ceramic, glass, natural stone such as granite or basalt, or a combination of these material classes is coated with a mixture of glycerol-based reactive 2K bio-epoxy resin and recyclable hardener, which contains an inorganic salt containing crystal water as an additive. This layer represents the reactive separation plane. Modification: To improve the separation effect, one or more layers of thin films made of a water-soluble polymer (e.g. polyvinyl alcohol) can be glued to the surface of the separation plane using the same bio-resin mixture. In the best case, this can lead to the elimination of the inorganic salt containing crystal water and thus also the subsequent heating during the separation, which represents a particularly resource-saving variant of the separation process, which only involves placing the components in the mildly acidic aqueous solution.

The ceramic modified in this way is then combined with a PU foam (back-foaming), whereby the PU foam ensures adhesion to the ceramic. The separation occurs through the release of crystal water in the separation plane. The special environmentally friendly bio-based epoxy resin mixture serves as a carrier for the inorganic salt and has the special feature that it can be easily removed from the components. The salt dissolves in the water.

### In Detail:

100 g of a BPA-free epoxy resin, e.g. of a glycerol-based polyol MF (C₁₂H₂₀O₆), a 3-aminomethyl-3,5,5-trimethyl-cyclohexyl-amine and a cyclohexane-carbonitrile-5-amino-1,3,3-trimethyl with a proportion of >90% of renewable raw material is mixed with 36 g of an acid-labile curing agent of a diaminoacetal (mixture of 2,2-bis(aminoethoxy)propane, 2-aminoethanol and ethanolamines) at room temperature. Then 10 g Na₂CO₃19 10H₂O are ground and homogeneously introduced into the mixture of resin and hardener component. The adhesion promoter mixture is then applied to the surface of the cover layer, for example a ceramic plate made of alumina, feldspar, aluminum and silicon carbide or a surface made of glass, natural stone such as granite or basalt, or a combination of these material classes, and cured for 24 hours at room temperature. Alternatively, one or more layers of water-soluble film can also be glued onto the layer in order to achieve a slightly modified separation mechanism or to increase the effectiveness of the dissolution of the adhesive layer.

After 24 hours, the treated cover layer is placed in a hot-pressing system and back-foamed with a reactive polyurethane foam and joined with the other components required to produce a floor element. In this case, the reactive foam can consist of a polyol mixture which contains an alkylaminocarboxamide, an alkoxylated alkylamine, a benzyldimethylamine and an N,N-dimethylcyclohexylamine in different relative concentrations. Likewise, other additives (such as common catalysts, blowing agents, stabilizers, etc.) can be incorporated into the polyol mixture to modify the reactivity and mechanical properties. For foaming, the polyol components are combined with a diphenylmethane diisocyanate consisting of isomers and homologues. After the foaming process, the finished composite component is assembled and cured for a further 24 hours at room temperature.

A particularly sustainable variant for the composite component is created by using a polyol mixture based on renewable raw materials, so-called bio-based polyols. Such polyols usually contain a proportion of 10% to over 90% of renewable raw materials (e.g. from so-called Cashew Nutshell Liquids—CNSLs). As a concrete example, formulations of such a cashew nut shell polyol mixture consisting of a CNSL Mannich polyol with water and Ecomate as a blowing agent and a DABCO catalyst in a mixing ratio of 1:1 with a diphenylmethane diisocyanate consisting of isomers and homologues can be mentioned. With this approach it is possible to increase the proportion of renewable raw materials in the PU foam core to over 40%. The following Table 1 shows examples of possible mixing ratios for the polyol with water and Ecomate as blowing agent:

TABLE 1

| | CNSL polyol | PU | Water | Ecomate | DABCO |
|---|---|---|---|---|---|
| No. | [g] | [g] | [mL] | [g] | [mL] |
| 1 | 20 | 20 | 0.5 | 5 | |
| 2 | 20 | 20 | 0.5 | | |
| 3 | 10 | 10 | | 2 | |
| 4 | 10 | 10 | | | 0.5 |
| 5 | 10 | 10 | 0.5 | | 0.2 |
| 6 | 10 | 10 | | 2 | 1 |
| 7 | 10 | 10 | | 2 | 2 |
| 8 | 10 | 10 | 1 | | 1 |
| 9 | 10 | 10 | 2 | | 1 |
| 10 | 12 | 16 | 1 | | 1.5 |
| 11 | 12 | 17 | 1 | | 1 |
| 12 | 10 | 12 | 1 | | 1 |
| 13 | 10 | 12 | 2 | | 1 |
| 14 | 10 | 12 | 1 | | 2 |
| 15 | 10 | 12 | 2 | | 2 |
| 16 | 10 | 12 | 1 | | |
| 17 | 10 | 12 | 3 | | |

To reuse the cover layer, the entire floor element is heated to 105° C. and the additive in the adhesion promoter releases the crystal water, which remains temporarily/completely under the film layer. This allows the foam and the adhesion promoter to be removed from the surface. By placing the components in an acid bath (15-25% ethyl acetate), both the surface and the foam can be completely removed from the adhesion promoter.

The cover layer can be reused without further steps in the production process and the foam can be recycled according to type after the remaining components of the floor system have been removed. The ethyl acetate solution can be reused for another separation process. If used several times, the dissolved adhesion promoter collects in the solution and can be extracted as thermoplastic after the solution has been neutralized.

### Example 2: Production of a Recyclable Thin Reinforcing Layer made of Natural Fibers for Thin Surfaces made of Ceramic, Glass, Natural Stone, or a Combination of these Material Classes

Adhesive layer: BPA-based 2K bio-epoxy resin system with an acid-labile recyclable hardener with the addition of copper (II) sulfate pentahydrate (CuSO₄·5H₂O)

### Brief Description of the Disclosed Materials:

The thin surface is coated with a mixture of the BPA-based reactive 2K bio-epoxy resin and an acid-labile hardener, which contains an inorganic salt containing crystal water as an additive, and then joined with a natural fiber scrim or fabric made from flax, hemp, bamboo, kenaf, etc. The epoxy resin ensures adhesion to the fiber fabric. The surface modified in this way is made break-proof and can serve as a break-proof surface for various applications by being glued to other carrier materials (substrates). After use, the surface can be separated from the substrate by heating and the subsequent release of crystal water in the parting plane. The special environmentally friendly bio-based epoxy resin mixture serves as a carrier for the inorganic salt and has the special feature that it can be easily removed from the components. This means that the surface and the reinforcing fiber can be completely freed of resin and then reused or the flax fiber can be composted. The salt dissolves in the water.

### In Detail:

100 g of an epoxy resin, e.g. based on bis-[4-(2,3-epoxipropoxi) phenyl]propane, containing >20% of renewable raw materials, is mixed with 31 g of a hardener of a diaminoacetal (mixture of 2,2-bis(aminoethoxy) propane, 2-aminoethanol and ethanolamines) at room temperature. Then 12 g CuSO₄19 5H₂O are ground and homogeneously introduced into the mixture of resin and hardener component. The adhesion promoter mixture is then applied to the surface of a thin (1-12 mm thick) plate made of natural stone, glass, ceramic or a combination of these material classes. A layer of the fiber fabric is applied to this layer for reinforcement and everything is cured for 24 hours until the resin mixture is completely cross-linked.

After 24 hours, the surface can be reused and can be combined with other materials as required for assembly. An exemplary application is back-foaming. For this purpose, the treated surface is placed in a hot-pressing system and back-foamed with a reactive foam made of polyurethane. An example of the composition of the reactive foam is a mixture of a polyol mixture which contains an alkylaminocarboxamide, an alkoxylated alkylamine, a benzyldimethylamine and an N,N-dimethylcyclohexylamine in different relative concentrations, with a diphenylmethane diisocyanate consisting of isomers and homologues. After the foaming process, the finished composite component is assembled and cured for a further 24 hours at room temperature.

To reuse the surface, it or the entire component manufactured with it is heated to 105° C. and the additive in the adhesion promoter releases the crystal water, which remains temporarily/completely under the film layer. This allows the fiber fabric, including any additional layers of material, to be removed from the surface. By placing all components in an acid bath (15-25% ethyl acetate), both the surface itself and any other layers of material connected to it can be completely removed from the adhesive layer. The natural fiber fabric is also loosened and cleaned.

After drying, this can either be reused or composted. The thin surface can be reused without further steps in the production process, as can the additional components, which can be recycled if necessary. The ethyl acetate solution can be reused for another separation process. If used several times, the dissolved adhesion promoter collects in the solution and can be extracted as thermoplastic after the solution has been neutralized.

### Example 3: Production of a Recyclable PUR Insulating Panel with a Structural (Decorative) Cover Layer for Use as a Facade Element

Adhesive layer: BPA-free glycerol-based 2K bio-epoxy resin with an acid-labile recyclable hardener with the addition of Na₂CO₃·10H20

### Brief Description of the Disclosed Materials:

A PUR foam core is coated on the surface with a mixture of glycerol-based reactive 2K bio-epoxy resin and recyclable hardener, which contains an inorganic salt containing crystal water as an additive. This layer represents the reactive separation plane and provides adhesion to the structural cover layer, such as a thin sheet of steel or aluminum, a surface made of natural stone or ceramic, a manufactured fiber-reinforced thermoset laminate, etc. The foam core is glued to the corresponding cover layer. The surface material primarily serves to stiffen, stabilize and protect the foam material, but can also have a decorative function. Such a PUR insulating panel can therefore also serve as a functional facade element. After use, the surface can be separated from the substrate by heating and the subsequent release of crystal water in the parting plane.

### In Detail:

100 g of a BPA-free epoxy resin, e.g. of a glycerol-based polyol MF (C12H₂₀O₆), a 3-aminomethyl-3,5,5-trimethyl-cyclohexyl-amine and a cyclohexane-carbonitrile-5-amino-1,3,3-trimethyl with a proportion of >90% of renewable raw material are mixed with 36 g of an acid-labile curing agent of a diaminoacetal (mixture of 2,2-bis(aminoethoxy) propane, 2-aminoethanol and ethanolamines) at room temperature. Then 10 g Na₂CO₃·10H₂O are ground and homogeneously introduced into the mixture of resin and hardener component. The adhesion promoter mixture is then applied to the surface of a PUR foam board of any size and then connected to the corresponding structural cover layer (sheet metal, laminate, board). The element prepared in this way is then cured for 24 hours at room temperature.

To reuse the cover layer, the entire floor element is heated to 105° C. and the additive in the adhesion promoter releases the crystal water, which remains temporarily/completely under the film layer. This allows the cover layer including the adhesion promoter to be detached from the foam core. By placing the cover layers and the foam components in an acid bath (15-25% ethyl acetate), both can be freed from the adhesion promoter.

The cover layer can be reused without any further steps and the foam core can be recycled according to type. The ethyl acetate solution can be reused for another separation process. If used several times, the dissolved adhesion promoter collects in the solution and can be extracted as thermoplastic after the solution has been neutralized.

### Example 4: Production of a Recyclable Wall Element made of PLA Particle Foam and a Cover Layer made of a Fiber-Reinforced Thermoset Laminate Composite

Adhesive Layer: Highly Conductive Water-Based Acrylic Polymer Dispersion, with a Proportion of at least 50% Conductive Carbon Nanotubes with the Addition of Na₂CO₃·10H₂O

### Brief Description of the Disclosed Materials:

A layer of a fiber-reinforced thermoset laminate composite, for example glass fiber epoxy laminate, is coated with a conductive acrylic polymer dispersion (so-called heating paint), which contains an inorganic salt containing crystal water as an additive. This layer represents the reactive separation plane. The modified glass fiber epoxy cover layer is then combined with a PLA particle foam, with adhesion being guaranteed either by the heating paint itself, the melting of the foam or by an additional adhesion promoter. The separation occurs by connecting a power source to previously attached contacts (copper foil) and the resulting heat, which triggers the release of crystal water in the separation plane.

### In Detail:

100 g of a highly conductive water-based acrylic polymer dispersion, with a proportion of at least 50% conductive carbon nanotubes, are mixed with 10 g of ground Na₂CO₃·10H₂O. The adhesion promoter mixture is then applied to the surface of a fiber-reinforced thermoset laminate composite, for example glass fiber epoxy laminate as a 5 mm film. To contact the conductive adhesive layer, a 35 μμm thick copper foil with a non-conductive, thermoset acrylic adhesive, which is supplied on a removable silicone release film, is applied to the adhesion promoter layer at the edges of the component. A slight overhang of the film serves as a contact surface for the electrodes of a power generator. The laminate cover layer is then either dried with the adhesion promoter mixture (at least 60 minutes) or, while still in the non-crosslinked state, is then manufactured, for example in a double belt press with a foam core made of PLA particle foam. The assembly can also be carried out using an additional adhesion promoter between the cover layer and the PLA core. Such a structure can, for example, result in a sustainable insulating wall element for applications in the transportation sector. To increase the efficiency of the separation process, the adhesion promoter mixture can be applied in several layers, with the fresh layer always having to dry in between before another layer is added. This increases the current generated in the adhesive layer and thus also the heat input.

To separate the cover layer (laminate) from the PLA foam core, the component is connected to the contact electrodes of a power supply via the protruding contact surfaces of the copper foil. The adhesive layer is heated by applying a voltage of 30-60 V with a current of at least 2.0 amperes. This heats the adhesive layer to a temperature of at least 100° C., which releases the crystal water in the adhesion promoter, which results in a physical separation of the cover layer from the foam core.

### Example 5: Production of a Recyclable Fiber-Reinforced Thermoformable Cover Layer for Manufacturing the Upper and/or Lower Belt in Board Sports Equipment such as Skis, Snowboards, Skateboards or Surfboards

Adhesive layer: BPA-based bio-epoxy resin component and thermolabile polyimine hardener component with the addition of Na2CO₃·10H₂O

### Brief Description of the Disclosed Materials:

A natural fiber scrim or fabric made from flax, hemp, bamboo, kenaf, etc. is soaked with a mixture of bio-epoxy resin components, thermolabile polyimine hardener and Na₂CO₃·10H₂O and then cured. This creates a so-called prepreg which, with the correct selection of the polyimine hardener, is stable at room temperature and can be shaped as desired in the temperature range of 70 to 80° C. In this temperature range, the prepreg also develops an adhesive effect to other materials and can be applied as a cover layer, top/bottom belt in the production of board sports equipment. The cover layer created in this way is break-resistant due to the fiber reinforcement and, thanks to the thermoset crosslinking of the matrix, can serve as a break-resistant surface for various applications by being glued to other carrier materials (substrates). After use, the surface can be separated from the substrate by heating to over 80° C. This even works without the addition of the additive containing crystal water. A better separating effect is achieved with the additive containing crystal water when heated to temperatures above 100° C.

The special bio-resin mixture with polyimine hardener allows the resin system to be completely dissolved by adding an excess of the corresponding imine monomer (30-50% by volume in ethanol or ethyl acetate).

### In Detail:

200 g of a polyimine hardener consisting of an imine mixture of protected composition, a diethylene triamine and a 4,4′-diamino-dicyclo-hexylmethane are heated to 90° C. while stirring using a heating stirrer or an infrared lamp or an electromagnetic induction loop. In addition, 2-10% by weight of a solvent from the group butanone, xylene or isopropyl alcohol can be added to reduce the viscosity, but not necessarily. For this purpose, 100 g of an environmentally friendly epoxy resin based on bis-[4-(2,3-epoxipropoxi) phenyl] propane is added with a >20% proportion of renewable raw materials and this mixture is stirred at a temperature of 60° C. for further 5 minutes. Optionally, 10-30 g of an inorganic salt containing crystal water, such as Na₂CO_{3·10}H₂O, can be added. The finished mixture is applied to a natural fiber scrim or fabric made from flax or hemp at 40° C. The prepreg produced in this way is then cured for 24hours at room temperature and then, after reheating to over 80° C. or before curing in the non-crosslinked state, pressed with an appropriate substrate, such as a surfboard or ski core, as a cover layer and then cured for at least 24 hours at room temperature. To separate the layers, the component is heated to 80° C.-90° C. for at least 3 minutes until the adhesive layer starts to “flow” or to over 100° C. until the contained crystal water escapes. In this state, the cover layer can be easily removed from the corresponding substrate and either reused in the same state or dissolved by placing it in an aqueous ethyl acetate solution with a proportion of 1-50% of the corresponding imine monomer or triethylenetetramine (TETA) in the building blocks of the adhesion promoters, which can then be reused after processing as raw materials for the production of the same. This means that the upper/lower belt of the sports equipment can either be completely reused, broken down into its components (matrix and fiber) or completely recycled.

Further details on variants of embodiment and material classes

### Heat Supply

The heat is supplied via heating plates, in the heating oven or any external heating elements. By adding conductive additives to the adhesives according to the present disclosure, the heat can also be supplied more efficiently via induction or by introducing microwave radiation by exploiting permanent dipole moments of the polymer composition or by using appropriate additions and additives. A more efficient heat supply makes an additional contribution to improving the ecological balance.

### Separation

In the variant with additives in the adhesion promoter, the layers are separated by heating the entire component or specifically the layer that contains the modified adhesion promoter. This is done by applying thermal heat from outside over a period of between one and 240 minutes, electromagnetic radiation (e.g. microwaves, IR radiation) over 10 to 480 seconds or through induction over 10 to 480 seconds using a device that contains an induction coil. Due to the special selection of adhesion promoters (bio-based with a low glass transition temperature) and additives, temperatures below 110° C. are sufficient to activate the thermally decomposable substances or dissolve the adhesive effect, which results in a particularly energy-efficient separation and a gentle separation process on the material layers. This has a positive impact on the environment both in terms of the energy balance and the possibility of reusing (recycling) the separated materials. The variant with the water-soluble film can improve separation by placing it in water.

The components of the parts are mechanically separated from each other after successful activation of the additives in the polymer or dissolution of the water-soluble adhesive layer. By using switchable thermolabile hardeners to crosslink the resins, the separated components can be completely freed from the adhesion promoter by applying heat at temperatures as low as 40 to 80° C. and/or solvents containing imine or triethylenetriamine (proportion of imine or triethylenetriamine of 10 to 50% by volume) and reused after subsequent processing.

### Adhesion Promoter Composition

Bio-based resins from the class of epoxy resins with or without BPA, the class of unsaturated polyester resins and the class of polyacrylate resins are used as the binder matrix for the adhesion promoters according to the present disclosure in conjunction with acid-labile diamine-acetal and diamine-ketal-based or thermolabile polyimine-based hardeners.

In addition to the binder matrix components mentioned, the adhesives according to the present disclosure can contain additives in proportions by weight of 0.1 to 40, which have the purpose of making the binder matrix conductive. These include, for example, carbon fiber residues from the production of carbon fiber fabrics, carbon fiber mats, carbon fiber composites, recycling processes of carbon fiber composites, by-products from the processing of carbon fibers as well as carbon fiber semi-finished products and carbon fiber composites, carbon fiber powder, carbon nanotubes, graphite powder and graphite fibers as well as various other carbon fiber modifications that either come from recycling processes or can be obtained from waste streams in the carbon fiber composites industry. Depending on the fiber length, particle size or raw material shape, it may be necessary to prepare the carbon fiber-based additives through grinding and shredding processes so that they can be mixed homogeneously with the adhesion promoter. The incorporation of these additives causes the adhesion promoter to become conductive and can be heated by induction or electromagnetic radiation. After appropriate preparation and comminution, the additives are incorporated homogeneously by mixing either into both or one of the separate adhesion promoter components or into the mixture consisting of both components.

To achieve the separating effect, the adhesion promoters according to the present disclosure contain the non-toxic and environmentally friendly thermally activated substances mentioned above, for example. For an effective release effect, these must be homogeneously distributed in the binder matrix and must not have any effect on the adhesive properties at room temperature. When heated, the additives either caused the release of water from the crystal lattice or expanded in volume (hollow microspheres), which contributed to the softening of the mechanical strength and thus physically to the bond breaking of crosslinking points of the binder matrix. Due to their strong expansion pressure, both the water-forming and the thermally expanding substances cause the adhesive bond to loosen or the adhesive effect to be significantly weakened, so that the adhesive bond can be separated under light mechanical stress. A concrete example of such substances is sodium carbonate decahydrate (Na₂CO₃·10H₂O) or non-toxic thermally expandable hollow microspheres consisting of a thermoplastic copolymer shell. These are dispersed into the binder in amounts between 5 and 30% by weight. ps Application Details

In order to ensure that the material layers can be separated, a thin (0.1-4 mm) layer of the adhesion promoter is applied to one or both surfaces of the material layers to be connected. This may need to be prepared, i.e. the required components (resin, hardener, additives, etc.) must be mixed together in advance. After application of the adhesion promoter, the material layers are connected to one another depending on the process of use, that is, brought into contact with one another and, if necessary, heated to temperatures between 60° C. and a maximum of 80° C. if faster crosslinking of the resin components is desired. The actual temperature or time required for the resin matrix to fully harden depends individually on the resin system selected. A modification of this process is the introduction of the water-soluble film with the help of the adhesion promoter between the material layers to be connected. The film serves, so to speak, as an additional separating layer that bonds both layers of material together through the adhesive effect of the adhesion promoter. To do this, the adhesion promoter is applied as a thin layer of 0.1-1 mm to both the substrates (components to be bonded) and to the film and all layers are bonded together.

Both adhesion promoters, additives and the film have either no or minimal influence on the chemical, physical and mechanical properties of the layers, so that the mechanical, physical and chemical properties of the composite structure change minimally or not at all. In addition, the material properties (chemical composition, mechanical properties) of the different layers are only minimally or not modified at all even after separation, so that the separated materials can either be recycled according to type, reprocessed or reused in the same condition.

The application of the adhesion promoter and the connection of the material layers can take place before the actual processing of the component or directly in the actual processing or connection process of the material layers to form a finished component. Care must be taken to ensure that an increased processing temperature does not lead to accelerated hardening of the adhesion promoter layer on one of the material layers before it is brought into contact with the second layer to be connected.

### Composite Parts:

The composite components (material layers) are, but not exclusively, multi-layer structures that contain at least one carrier material (substrate) and at least one further material as a cover layer. The materials can either all consist of the same material or different materials. The carrier material can, but does not have to, be made of metal (e.g. aluminum), a metal alloy (e.g. iron-carbon alloy), a ceramic material (e.g. various compositions of clay, feldspar, aluminum and silicon carbide, or kaolins, silicates, oxides and nitrides), a thermoplastic (PET, ABS, PP, PA, PS and their modifications) and/or thermoset polymer (e.g. epoxy, unsaturated polyester, phenol, melamine, urea or polyurethane thermosets), a foam (e.g made of polyurethane, especially a polyurethane foam with a proportion of over 40% renewable raw materials, polystyrene, lignin-based materials, cellulose, PET, PP) or a combination of these materials. In addition, one of these materials can, but does not have to, be additionally reinforced by organic and/or inorganic fibers. These include, for example, glass fibers, carbon fibers, aramid fibers, flax fibers, bamboo fibers, hemp fibers, etc. The further material layer can, but does not have to, have either the same composition as the carrier material or any material combination of the mentioned material variations of the substrate. Often, but not necessarily, these so-called composite materials contain a symmetrical structure (a so-called sandwich structure) made of at least one substrate (bottom belt), at least one core material and at least one cover layer (top belt), with all layers made of the same material or wherein each can consist of any combination of the materials mentioned, but does not necessarily have to.

The present disclosure is not limited to the examples given, the materials mentioned in these examples can be combined differently, and with knowledge of the disclosure it is easy for the person skilled in the art to find other adhesive compositions based on a few simple experiments. All temperatures given are degrees Celsius, unless otherwise stated, all composition details are percentages by weight.

In summary, one can say that the invention relates to a composite material, in particular a recyclable composite material, consisting of at least two layers of material which are connected to one another by a layer of adhesive. For easy and clean separation of the two material layers, it is intended that the adhesive consists of a material that gives off and/or generates water vapor when heated to over 100° C., thereby separating the composite into its constituents.

In the description and claims, the terms “front”, “back”, “top”, “bottom” and so on are used in the generic form and with reference to the object in its usual state of use. This means that in the case of a weapon, the mouth of the barrel is “front”, that the lock or sledge is moved “back” by the explosion gases, etc. For vehicles, “front” is the usual direction of travel. When it comes to the slope of a monorail, and not to the running rail(s), “running direction” refers to this direction on the slope. Transverse essentially means a direction that is rotated by 90° and is essentially horizontal.

It should also be noted that in the description and claims, information such as “lower region” of a slope, reactor, filter, structure, or device or, more generally, of an object, means the lower half, and in particular the lower quarter of the total height, “lowest range” means the lowest quarter and, in particular, an even smaller part; whereas “medium region” means the middle third of the total height (width−length). All of this information has its common meaning, applied to the intended position of the object under consideration.

In the description and claims, “substantially” means a deviation of up to 10% of the specified value, if physically possible, both downwards and upwards, otherwise only in the reasonable direction, in the case of degrees (angle and temperature) this means ±10°.

All quantities and proportions, in particular those defining the invention, as long as they do not relate to the specific examples, are to be understood with a tolerance of ±10%, so for example: 11% means: from 9.9% to 12.1%. For designations such as: “a solvent”, the word “a” shall not be regarded as a numerical word but as an indeterminate article or an advocate, unless otherwise indicated in the context.

The term “combination” or “combinations” means, unless otherwise specified, all types of combinations, starting from two of the corresponding components up to a large number or all of such components, the term “containing” also means “consisting of”.

The features and variants specified in the individual embodiments and examples can be freely combined with those of the other examples and embodiments and can be used in particular to characterize the invention in the claims without necessarily including the other details of the respective embodiment or example.

1. A compound material, comprising:
at least two material layers bonded by a layer of an adhesive, wherein the adhesive includes a material that produces water vapor when heated to more than 100° C.

2. The compound material according to claim 1, wherein the adhesive includes a material that when placed in a weakly acidic aqueous solution loses its adhesive effect.

3. The compound material according to claim 1, wherein he adhesive includes a material that when heated to temperatures between 80° C. and 180° C. loses its adhesive effect.

4. The compound material according to claim 1, wherein the adhesive includes a BPA-free glycerol-based 2K bio-epoxy resin with an acid-labile recyclable hardener with the addition of 0.5% by weight to 35% by weight of Na₂CO₃·10H₂O.

5. The compound material according to claim 1, wherein the adhesive includes a BPA-based 2K bio-epoxy resin system with an acid-labile recyclable hardener with the addition of 0.5% by weight to 35% by weight of copper (II) sulfate pentahydrate (CuSO₄·5H₂O).

6. The compound material according to claim 1, wherein the adhesive includes a BPA-based 2K bio-epoxy resin system with an acid-labile recyclable hardener with the addition of 0.5% by weight to 35% by weight of Na₂CO₃·10H₂O.

7. The compound material according to claim 1, wherein the adhesive includes an electrically highly conductive, water-based acrylic polymer dispersion, with a proportion of at least 0.5% by weight of conductive carbon nanotubes, with the addition of 0.5% by weight to 35% by weight of Na₂CO₃·10H₂O.

8. The compound material according to claim 1, wherein the adhesive includes a BPA-based bio-epoxy resin component and a thermolabile polyimine hardener component, with the addition of 0.5% by weight to 35% by weight of Na₂CO_{3·10}H₂O.

9. The compound material according to claim 1, wherein at least one of the two material layers is a wood, a glass, a ceramic, a natural stone, a polymer, a fiber fabric or a composite thereof, or a metal.

10. The compound material according to claim 1, wherein the compound material is fully recyclable.

11-16. (canceled)

17. The compound material according to claim 10, wherein all of the components of the compound material are fully recyclable, except for the layer of the adhesive.

18. The compound material of claim 1, wherein the adhesive includes a material that gives off water vapor, or generates water vapor, when heated to more than 100° C.

19. The compound material according to claim 9, wherein at least one of the two material layers is a wooden panel, a wooden board, a wooden veneer, a wooden fabric, a wooden scrim, or a wood composite.

20. The compound material according to claim 9, wherein at least one of the two material layers is a glass pane, a glass composite, or a glass plate.

21. The compound material according to claim 9, wherein at least one of the two material layers is a ceramic tile, a ceramic plate, or a ceramic composite.

22. The compound material according to claim 9, wherein at least one of the two material layers is a natural stone slab, a natural stone composite, or a natural stone tile.

23. The compound material according to claim 9, wherein at least one of the two material layers is a thermoplastic polymer or a thermoset polymer.

24. The compound material according to claim 23, wherein at least one of the two material layers is a PP, a PET, a PLA, a PA, a PU, an ABS, a polyester, or an epoxy.

25. The compound material according to claim 23, wherein at least one of the two material layers is a fiber-filled polymer, a polymer plate, a polymer film, a polymer layer, or a roll goods.

26. The compound material according to claim 9, wherein at least one of the two material layers is aluminum.

27. The compound material according to claim 1, wherein the compound material includes a share of regenerative and bio-based raw materials in the layer of the adhesive that is at least 24% by weight, when measured according to ASTM D6866 based on a share of carbon from renewable sources in a molecular structure of the layer of the adhesive.

28. The compound material according to claim 27, wherein the regenerative and bio-based raw materials are derived from epoxidized vegetable oils or epoxidized sorbitol and glycerol derivatives.

29. The compound material according to claim 28, wherein the regenerative and bio-based raw materials are derived from epoxidized soybean oil, epoxidized castor oil, epoxidized linseed oil, or epoxidized cashew nut shell oil.

30. A method for releasing a bond of a compound material, the compound material having at least two material layers bonded to one another by a layer of an adhesive that includes a material that produces water vapor when heated to more than 100° C., the method comprising:
heating the compound material to over 80° C.

31. The method of claim 30, wherein heating the compound material to over 80° C. includes heating the compound material to over 100° C.

32. The method of claim 30, wherein heating the compound material to over 80° C. includes not heating the compound material to over 160° C.

33. The method of claim 30, further comprising cleaning at least one of the material layers by storing the material layer for up to 24 hours in a mildly acidic aqueous solution.

34. The method of claim 33, wherein the mildly acidic aqueous solution is a 25% aqueous ethyl acetate solution.

35. The method of claim 30, further comprising cleaning at least one of the material layers by storing the material layer for up to 12 hours in a mildly acidic aqueous solution that is a 25% aqueous ethyl acetate solution at between 40° C. and 80° C.

36. The method of claim 30 further comprising cleaning at least one of the material layers by storing the material layer for up to 24 hours in a water-ethanol solution.

38. The method of claim 36, wherein the water-ethanol solution is at a temperature of 40° C. to 50° C.
